(19) United States
(12) Patent Application Publication
(10) Pub. No.: US 2017/0032480 A1
(43) Pub. Date: Feb. 2, 2017

(54) PERSONALIZED TRAVEL PLANNING AND GUIDANCE SYSTEM

(71) Applicant: Chi Him Wong, Hong Kong (HK)

(72) Inventors: Chi Him Wong, Hong Kong (HK); Heung Yu Ng, Hong Kong (HK)

(21) Appl. No.: 15/224,837

(22) Filed: Aug. 1, 2016

Related U.S. Application Data
(60) Provisional application No. 62/200,111, filed on Aug. 2, 2015.

(51) Int. Cl. G06Q 50/14; G06N 99/00; G06Q 50/00; G06N 5/04

(52) U.S. Cl. CPC G06Q 50/14; G06N 5/04; G06N 99/005; G06Q 50/01

(57) ABSTRACT

Disclosed is system and method for providing a personalized travel planning and guidance to the user. The system may predict user's travel behavior based upon multiple inputs. The system may identify tourist attractions on a route matching with the user's travel behavior. The system may cluster the tourist attractions into different clusters. The system may compute shortest paths and predetermined durations for one or more tourist attractions associated to each cluster. The system may display a route and time schedule as a travel itinerary on a display device of the user. The system may predict deceleration of vehicle and provide a warning to the user if the deceleration value exceeds a predefined threshold. The system may further compute a safe optimal distance to decelerate the vehicle while entering a curve on the route and provide another warning to the user if the vehicle position is within the safe optimal distance.

CROSS-REFERENCE TO RELATED APPLICATIONS AND PRIORITY

The present application claims priority from U.S. Provisional Patent Application. No 62/200,111 dated Aug. 2, 2015, incorporated herein as a reference.

### TECHNICAL FIELD

The present subject matter described herein, in general, relates to a system and method for providing personalized travel planning and guidance to a user.

### BACKGROUND

With the advent of internet technologies, there has been a tremendous shift from conventional travel planning to more advanced travel planning schemes facilitated through various internet websites, travel portals, online travel agencies, and the like. Though, such online mechanisms have eased the task of planning travels, however, there are still numerous challenges faced by an individual planning for a travel. For example, the individual has to select appropriate sightseeing places/attractions from numerous sightseeing places/attractions available on a particular travel route. Further, the individual has to effectively plan the travel to accommodate each of the sightseeing places/attractions selected within the total travel duration planned by the individual. Further, little or no guidance information about various sightseeing places/attractions may be available to the individual. Furthermore, the existing mechanism lack in providing appropriate route paths to be selected for travelling on the travel route that would facilitate visiting all the sightseeing places/attractions within the total travel duration planned

Additionally, even though the individual plans the travel using whatever information he/she has, however, in event of unforeseen circumstances such as bad weather, peak traffic, accidents and holidays etc., the individual may have to cancel the travel plan or at least avoid visiting the locations thereby affecting the overall travel planned by the individual. Therefore, the existing processes of travel planning are erroneous, onerous and time consuming Furthermore, in the existing art, there lacks a mechanism for providing real time safe driving assistance while travelling on the roads/routes in order to avoid traffic prone regions, avoid crashing of the vehicles and accidents on the roads/routes.

### SUMMARY

This summary is provided to introduce concepts related to systems and methods for providing personalized travel planning and guidance to a user and the concepts are further described below in the detailed description. This summary is not intended to identify essential features of the claimed subject matter nor is it intended for use in determining or limiting the scope of the claimed subject matter.

In one implementation, a method for providing personalized travel planning and guidance to a user is disclosed. The method may comprise capturing, by a processor, user's input, user's personal data and user's social networking data, wherein the user's input comprises at least a travel destination and a travel duration. The method may further comprise analyzing, by the processor, the user's input, the user's personal data and the user's social networking data in order to predict user's travel behavior. Further, the method may comprise identifying, by the processor, a set of tourist attractions from a plurality of tourist attractions, on a travel route, matching with the user's travel behavior. The method may further comprise clustering, by the processor, the set of tourist attractions into a plurality of clusters based upon location information of each tourist attraction. Further, the method may comprise computing, by the processor, a shortest path and a predetermined duration for one or more attractions associated to each cluster. Further, the method may comprise determining, by the processor, a travel itinerary corresponding to at least one sub-duration of the travel duration based upon the shortest path and the predetermined duration computed for the one or more attractions associated to each cluster, wherein the travel itinerary is further displayed on a display device of the user.

In an embodiment, the method may further comprise predicting a deceleration of a vehicle, associated to the user, at a future time on the travel route and notifying the user with a warning on the display device if the deceleration exceeds a predefined deceleration threshold. In one aspect, the deceleration of the vehicle is predicted by: training, by the processor, a predictive model using at least historical map data, historical vehicle data, historical weather data, historical time data and historical location data; generating, by the processor, one or more features based upon the training of the predictive model; and computing, by the processor, the deceleration of the vehicle based upon real time data and the one or more features, wherein the real time data comprises at least map data, vehicle data, weather data, time data and location data.

In another embodiment, the method may comprise computing an optimal speed for the vehicle in order to enter a curve on the travel route, wherein the optimal speed is computed by: capturing, by the processor, travel route information, weather information, friction and super elevation rate of positions of the travel route, wherein the travel route information comprises shape points of the curve; determining, by the processor, a radius of best fit circle corresponding to a curve based upon the shape points of the curve, wherein the best fit circle is identified using a circle fitting technique; and calculating, by the processor, the optimal speed to enter the curve based upon the radius, the super elevation rate and a transverse friction force. The method may further comprise verifying, by the processor, whether the vehicle is within a safe optimum distance to decelerate, in order to enter a next curve, when a current speed of the vehicle is greater than the optimal speed, and wherein the safe optimum distance is calculated based on the current speed, the optimum speed and an optimal deceleration rate of the vehicle. Furthermore, the method may comprise notifying the user with an over speed warning on the display device if the current position of the vehicle is within the optimal distance.

In another implementation, a system for providing personalized travel planning and guidance to a user is disclosed. The system may comprise a processor and a memory coupled to the processor. The processor may be configured to execute programmed instructions stored in the memory. The processor may execute a programmed instruction to capture user's input, user's personal data and user's social networking data, wherein the user's input comprises at least a travel destination and a travel duration. The processor may further execute a programmed instruction to analyze the user's input, the user's personal data and the user's social networking data in order to predict user's travel behavior. Further, the processor may execute a programmed instruction to identify a set of tourist attractions from a plurality of tourist attractions, on a travel route, matching with the user's travel behavior. The processor may further execute a programmed instruction to cluster the set of tourist attractions into a plurality of clusters based upon location information of each tourist attraction. Further, the processor may execute a programmed instruction to compute a shortest path and a predetermined duration for one or more attractions associated to each cluster. Further, the processor may execute a programmed instruction to determine a travel itinerary corresponding to at least one sub-duration of the travel duration based upon the shortest path and the predetermined duration computed for the one or more attractions associated to each cluster, wherein the travel itinerary is further displayed on a display device of the user.

In an embodiment, the processor may further execute a programmed instruction in order to predict a deceleration of the vehicle at a future time on the travel route and notify the user with a warning on the display device if the deceleration exceeds a predefined deceleration threshold. In one aspect, the deceleration of the vehicle is predicted by: training a predictive model using at least historical map data, historical vehicle data, historical weather data, historical time data and historical location data; generating one or more features based upon the training of the predictive model; and computing the deceleration of the vehicle based upon real time data and the one or more features, wherein the real time data comprises at least map data, vehicle data, weather data, time data and location data.

In another embodiment, the processor may further execute a programmed instruction in order to compute an optimal speed for the vehicle to enter a curve on the travel route, wherein the optimal speed is computed by: capturing travel route information, weather information, friction and super elevation rate of positions of the travel route, wherein the travel route information comprises shape points of the curve; determining a radius of best fit circle corresponding to a curve based upon the shape points of the curve, wherein the best fit circle is identified using a circle fitting technique; and calculating the optimal speed to enter the curve based upon the radius, the super elevation rate and a transverse friction force. The processor may further execute a programmed instruction to verify whether the vehicle is within a safe optimum distance to decelerate, in order to enter a next curve, when a current speed of the vehicle is greater than the optimal speed. In an aspect, the safe optimum distance is calculated based on the current speed, the optimum speed and an optimal deceleration rate of the vehicle. Furthermore, the processor may execute a programmed instruction to notify the user with an over speed warning on the display device if the current position of the vehicle is within the optimal distance.

In yet another implementation, a non-transitory computer readable medium storing a program for providing personalized travel planning and guidance to a user is disclosed. The program may comprise a program code for capturing user's input, user's personal data and user's social networking data, wherein the user's input comprises at least a travel destination and a travel duration. The program may further comprise a program code for analyzing the user's input, the user's personal data and the user's social networking data in order to predict user's travel behavior. Further, the program may comprise a program code for identifying a set of tourist attractions from a plurality of tourist attractions, on a travel route, matching with the user's travel behavior. The program may further comprise a program code for clustering the set of tourist attractions into a plurality of clusters based upon location information of each tourist attraction. Further, the program may comprise a program code for computing a shortest path and a predetermined duration for one or more attractions associated to each cluster. Further, the program may comprise a program code for determining a travel itinerary corresponding to at least one sub-duration of the travel duration based upon the shortest path and the predetermined duration computed for the one or more attractions associated to each cluster, wherein the travel itinerary is further displayed on a display device of the user.

In an embodiment, the program may further comprise a program code for predicting a deceleration of the vehicle at a future time on the travel route and notify the user with a warning on the display device if the deceleration exceeds a predefined deceleration threshold. In one aspect, the deceleration of the vehicle is predicted by: training a predictive model using at least historical map data, historical vehicle data, historical weather data, historical time data and historical location data; generating one or more features based upon the training of the predictive model; and computing the deceleration of the vehicle based upon real time data and the one or more features, wherein the real time data comprises at least map data, vehicle data, weather data, time data and location data.

In another embodiment, the program may further comprise a program code for computing an optimal speed for the vehicle to enter a curve on the travel route, wherein the optimal speed is computed by: capturing travel route information, weather information, friction and super elevation rate of positions of the travel route, wherein the travel route information comprises shape points of the curve; determining a radius of a best fit circle corresponding to a curve based upon the shape points of the curve, wherein the best fit circle is identified using a circle fitting technique; and calculating the optimal speed to enter the curve based upon the radius, the super elevation rate and a transverse friction force. The program may further comprise a program code for verifying whether the vehicle is within a safe optimum distance to decelerate, in order to enter a next curve, when a current speed of the vehicle is greater than the optimal speed. In an aspect, the safe optimum distance is calculated based on the current speed, the optimum speed and an optimal deceleration rate of the vehicle. Furthermore, the program comprises a program code for notifying the user with an over speed warning on the display device if the current position of the vehicle is within the optimal distance.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation 100 of a system 102 for providing personalized travel planning and guidance to a user, in accordance with an embodiment of the present disclosure.

FIG. 2 illustrates the system 102, in accordance with an embodiment of the present disclosure.

FIG. 3A and FIG. 3B illustrates a user interface of a display device of the user facilitating capturing of one or more inputs from the user, in accordance with an embodiment of the present disclosure.

FIG. 4 illustrates a typical neural network layer, in accordance with an embodiment of the present disclosure.

FIG. 5 illustrates the user interface of the display device displaying shortest paths for one or more clusters in a travel route, in accordance with an embodiment of the present disclosure.

FIG. 6 illustrates a flow diagram 600 depicting steps performed by the system 102 for providing personalized travel planning to the user, in accordance with an embodiment of the present disclosure.

FIG. 7 illustrates an implementation of the system 102 in a vehicle, in accordance with an embodiment of the present disclosure.

FIG. 8 illustrates a chart demonstrating a time-series based prediction of deceleration of the vehicle, in accordance with an embodiment of the present disclosure.

FIG. 9 illustrates a flow diagram 900 depicting steps executed by the system 102 for predicting the deceleration of the vehicle and thereby avoiding crashing of the vehicle, in accordance with an embodiment of the present disclosure.

FIG. 10 illustrates a flow diagram 1000 depicting a time-series data based prediction modeling enabling the prediction of the deceleration of the vehicle, in accordance with an embodiment of the present disclosure.

FIG. 11 illustrates a flow diagram 1100 depicting steps performed by the system 102 for predicting a curve speed for the vehicle and thereby generating a curve speed warning for the user, in accordance with an embodiment of the present disclosure.

FIG. 12 illustrates a circle-fitting technique for determining a best fit circle of a curve on the travel route, in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

System(s) and method(s) for providing personalized travel planning and guidance to a user are described. According to the aspects of the present disclosure, a travel itinerary or a travel plan may be generated for a user based upon user's travel behavior/profile or travel preferences. The travel preferences of the user may be predicted using supervised machine learning techniques. The supervised machine learning technique may analyze the user's personal data and social networking data along with survey data for predicting the travel preferences. The travel itinerary or the travel plan comprises activities and sightseeing places/tourist attractions that suit user's travel style. In certain aspects of the disclosure, a location of the tourist attractions as well as the category of the attractions may be utilized to plan a trip that is optimized on distance travelled and the users' preferences.

After the generation of the travel plan, guidance information pertaining to each tourist attraction in the travel/trip route may be provided to the user. For example, when the user arrives at a location of a tourist attraction, suggestions and/or notifications based on real time travelling information associated to the tourist attraction is provided to the user. The travel itinerary or the travel plan may be adaptive and hence may be updated based on real-time factors such as weather, traffic, events, holidays, accidents and the like. Accordingly, the travel plan may be rescheduled automatically based on the said real-time factors.

In addition to the aforementioned guidance information, driving-assistance information may be provided to the user operating as a driver of the vehicle. The driving-assistance information may include traffic information on the travel route, vehicle deceleration predicted at a future time on the travel route and a safe optimal distance to decelerate the vehicle while entering curves on the travel route. The vehicle deceleration at the future time is predicted via a time-series prediction model trained using past driving data from multiple drivers. The time-series prediction model may predict the deceleration ahead when real time driving data is fed into the time-series prediction model. A warning may be provided to the driver if the driver is predicted to make a hard brake ahead.

The safe optimal distance to decelerate the vehicle may be calculated based on an optimal speed, a current speed of the vehicle and a safe deceleration value. The optimal speed to enter the curve may be computed based on a curve radius. The curve radius is the radius of the best fitted circle corresponding to the curve. The best fitted circle is identified based on shape points of the curve. A curve speed warning may be provided to the driver if the vehicle is decelerated at the safe optimal distance while entering the next curve on the travel route. While aspects of described system and method for providing personalized travel planning and guidance to a user may be implemented in any number of different computing systems, environments, and/or configurations, the embodiments are described in the context of the following exemplary system.

Although the present disclosure is explained considering that the system 102 is implemented as a server, it may be understood that the system 102 may also be implemented in a variety of computing systems, such as a laptop computer, a desktop computer, a notebook, a workstation, a mainframe computer, a network server, and the like. In one implementation, the system 102 may be implemented in a cloud-based environment. It will be understood that the system 102 may be accessed by multiple users through one or more display devices 104-1, 104-2, 104-3 . . . 104-N, collectively also referred to as display devices 104 hereinafter, or applications residing on the display devices 104. Examples of the display devices 104 may include, but are not limited to, a portable computer, a personal digital assistant, a handheld device, a wearable device, a workstation and an in-vehicle infotainment system present within a vehicle. The display devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

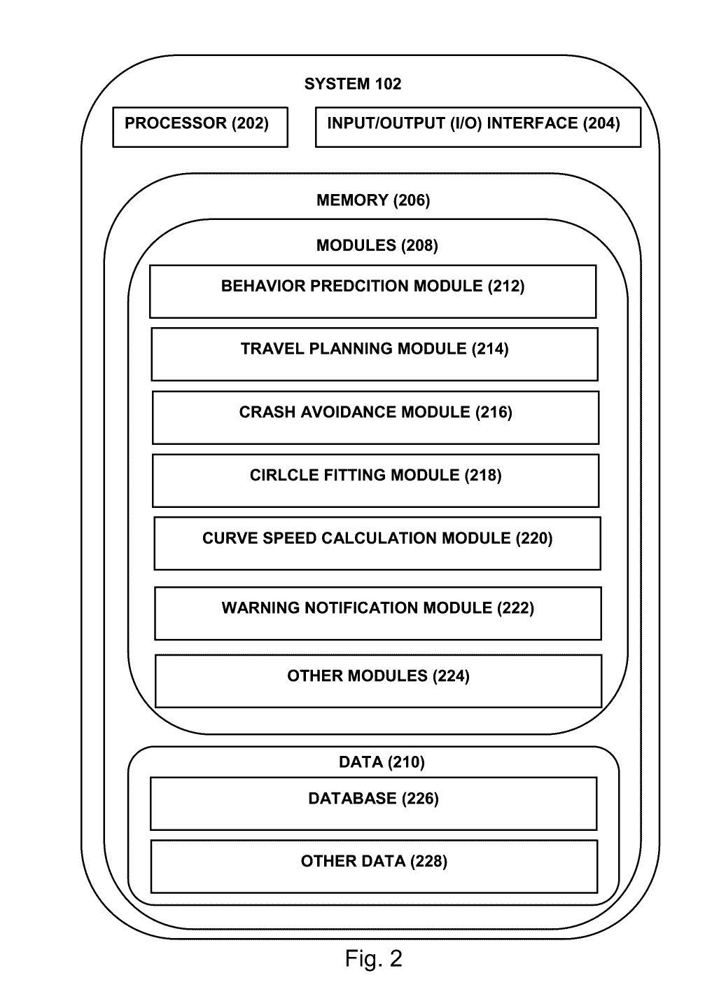

Referring now to FIG. 2, the system 102 is illustrated in accordance with an embodiment of the present disclosure. In one embodiment, the system 102 may include a processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable/programmed instructions stored in the memory 206.

The I/O interface 204 may include a variety of software and hardware interfaces, for example, a web interface, a graphical user interface, and the like. The I/O interface 204 may allow the system 102 to interact with a user directly or through the display devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a behavior prediction module 212, a travel planning module 214, a crash avoidance module 216, a circle fitting module 218, a curve speed calculation module 220, a warning notification module 222 and other modules 224. The other modules 224 may include programs or coded instructions that supplement applications and functions of the system 102.

The data 210, amongst other things, serves as a repository for storing data processed, received, and generated by one or more of the modules 208. The data 210 may also include a database 226 and other data 228. The other data 228 may include data generated as a result of the execution of one or more modules in the other modules 224.

In one implementation, at first, a user may use the display device 104 to access the system 102 via the I/O interface 204. The user may register himself using the I/O interface 204 in order to use the system 102. The working of the system 102 using the plurality of modules 208 is explained in detail referring to FIGS. 2-12 as explained below.

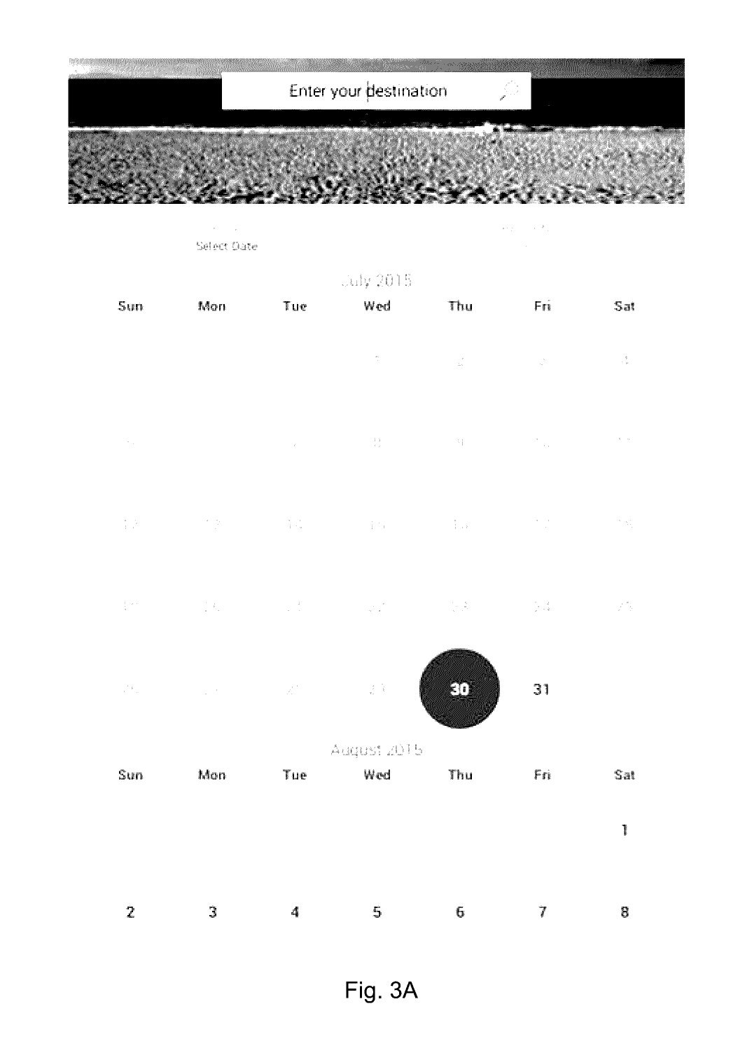

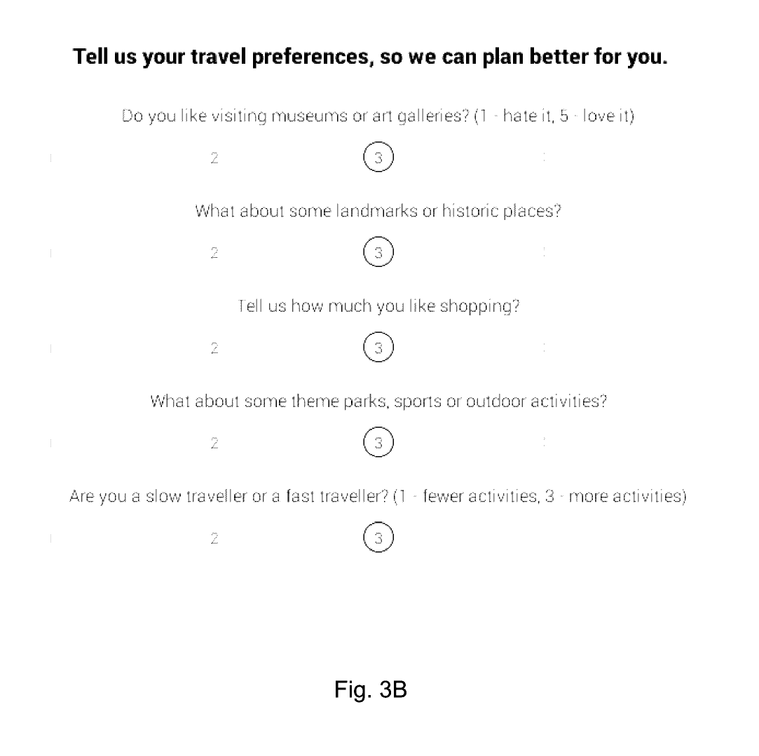

Referring to FIG. 2, the behavior prediction module 212 may be configured to predict travel behavior of the user 104. The travel behavior indicates travel preferences of the user. In one embodiment, in order to predict the travel behavior of the user, the behavior prediction module 212 may capture user's input, user's personal data and user's social networking data. The user's input may comprise at least a travel destination and a travel duration for the user. The user's input may be captured via a user interface, of the display device 104, as shown in FIG. 3A. Further, the user's input may comprise responses provided by the user corresponding to a travel survey conducted for capturing the travel preferences of the user. One such travel survey capturing the responses of the user is shown in FIG. 3B. As illustrated in FIG. 3B, the responses captured from the user may include, but not limited to, user's interest in museum/art gallery, landmarks/historical places, shopping, parks/sport/outdoor activities etc. The user's personal data may include, but not limited to, age, gender, country, income etc. The user's social networking data may include, but not limited to, user's comments, user's publications, user's likes, user's blogs on various social networking sites. In one embodiment, the user's input, the user's personal data and the user's social networking data captured may be stored in the database 226.

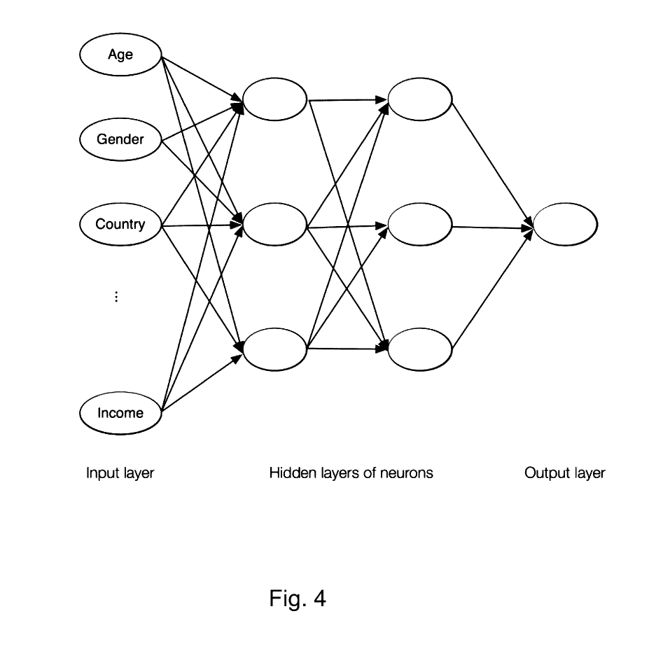

After the capturing and storing of the user's input, the user's personal data and the user's social networking data, the behavior prediction module 212 may be configured to analyze the aforementioned data in order to predict the travel behavior of the user. In an embodiment, the behavior prediction module 212 may predict the travel behavior based upon a supervised learning technique using data classification method. The data classification method used may include, but not limited to, a decision tree learning method or a neural network classification method. In one example, the behavior prediction module 212 may utilize a simple neural network shown in FIG. 4 to predict the travel behavior. As shown in FIG. 4, the user's input or the user's personal data or the user's social networking data or a combination thereof may be utilized in form of an input layer for the data classification method. The input layer along with the hidden layers (neurons) enables to provide an output layer indicating the travel behavior of the user. In other words, the output layer indicates categorization/classification of the travel behavior/travel profile of the user into at least one of predetermined categories. It is to be noted to one skilled in the art that the predicting an output based upon the supervised learning technique using the data classification method as discussed above is known in the art. Based upon the prediction of the travel behavior of the user, the travel planning module 214 shown in FIG. 2 may be configured to facilitate travel planning for the user on the travel route of the travel destination captured from the user, as described in detail hereinafter as below.

Referring to FIG. 2, the travel planning module 214 may be configured to generate a travel plan for the user based on analysis of the user's personal data and the travel behavior or the travel preferences predicted for the user. The travel plan includes a travel itinerary with activities and sightseeing places on the travel route of the user that suit user's travel behavior/travel profile. It must be understood that the database 226 may be configured to store a plurality of tourist attractions pertaining to different locations within a city or a state or a country and the like. The travel planning module 214 may be configured to identify a set of tourist attractions from the plurality of tourist attractions matching with the travel behavior of the user. In one example, if the travel behavior of the user indicates that the user's interest is in historical places, the travel planning module 214 may identify at least one tourist attraction pertaining to historical background such as forts, battle land etc. In another example, if the travel behavior of the user indicates that the user is more interested in adventure sports, the travel planning module 214 may identify at least one tourist attraction that facilitates mountaineering, trekking etc. In an embodiment, the number of attractions in the set of attractions is based upon the travel duration. Further, the travel planning module 214 may be configured to sort the set of tourist attractions based upon how close a tourist attraction is matching with the travel behavior/profile of the user.

The set of tourist attractions on the travel route of the user may be displayed on the display device 104 of the user. Further, the travel planning module 214 may cluster each tourist attraction of the set of tourist attractions into a cluster of a plurality of clusters. In one aspect, the number of clusters formed may be based upon number of days in the travel duration. In an embodiment, each tourist attraction is clustered into a specific cluster based upon location information of each tourist attraction. In other words, tourist attraction(s) with identical or equivalent location may be clustered into a same cluster. In one embodiment, the location information of each tourist attraction may be determined using a Global Positioning System (GPS) technique.

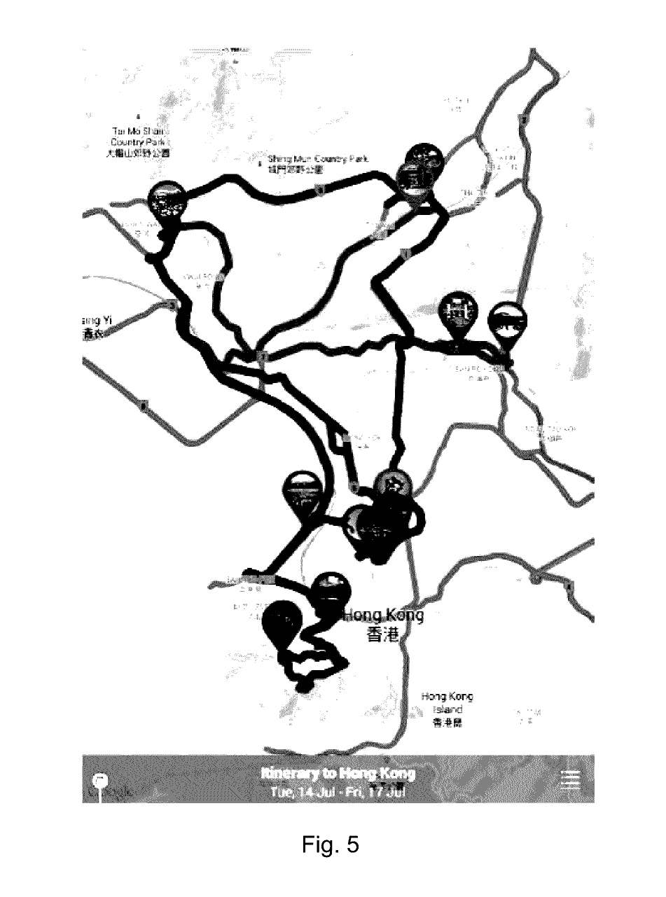

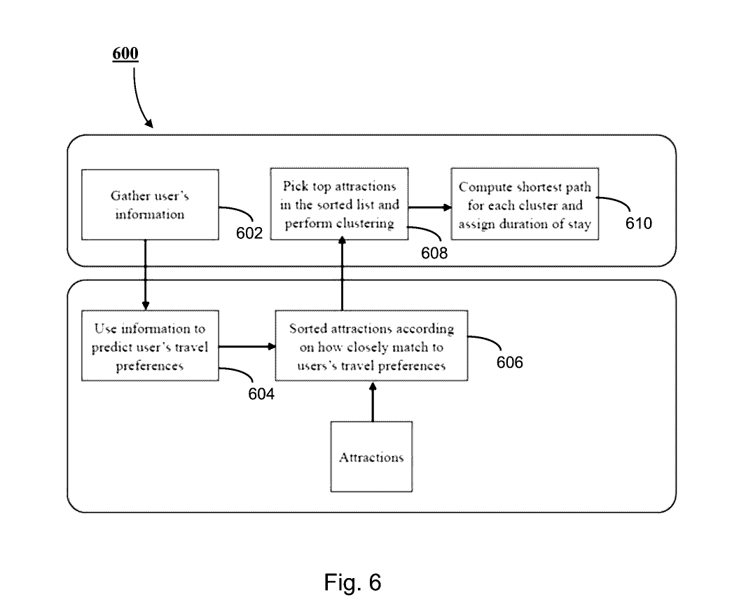

After the clustering of the set of tourist attractions, the travel planning module 214 may compute a shortest path and a predetermined duration, of the travel duration, for one or more tourist attractions associated to each cluster. In one embodiment, the shortest path may be indicative of a path, on the travel route that starts with a specific starting position, wherein the said path further traverses through each tourist attraction in the cluster and finally stops at an ending position. It must be understood that the shortest path is computed based upon a computational problem similar to the traveling salesman problem (TSP), wherein the TSP is a typical optimization problem for identifying a shortest path that visit all vertices. FIG. 5 illustrates an exemplary map displaying the shortest paths for the clusters in the travel route of the user, wherein the exemplary map is displayed on the user interface of the display device 104. Further, the predetermined duration is computed based upon one or more predefined factors including, but not limited to, a category of the one or more tourist attractions and an average time spend by tourists at the one or more tourist attractions. The predetermined duration herein indicates a time period of the travel duration during which the user may stay at one or more tourist attractions associated to each respective cluster. The travel planning module 214 may further determine a travel itinerary corresponding to at least one sub-duration of the travel duration based upon the shortest paths and the predetermined durations computed for the one or more tourist attractions associated to each cluster. The travel itinerary may further be displayed on the user interface of the display device 104. In one example, a route and time schedule in form of the travel itinerary for each day may be displayed on the display device 104. FIG. 6 illustrates a flow diagram 600 depicting the aforementioned steps performed by the system 102 using the behavior prediction module 212 and the travel planning module 214 for providing personalized travel planning, in accordance with an embodiment of the present disclosure.

As shown in FIG. 6, at block 602, the user's information (the user's input, the user's personal data and the user's social networking data) may be gathered. At block 604, the user's information is analyzed to predict user's travel preferences (travel behavior/profile). At block 606, the set of tourist attractions identified from the plurality of tourist attractions may be sorted based on how closely each tourist attraction of the set of tourist attractions is matched with the user's travel preferences. At block 608, few top tourist attractions in the sorted tourist attractions may be selected and clustered into multiple clusters. At block 610, a shortest path and a duration stay corresponding to each cluster may be computed and accordingly assigned to the said cluster.

After the determination of the travel plan for the user, the travel planning module 214 may guide the user on exploring the one or more tourist attractions of each cluster as per the travel planned for the user. In one embodiment, the travel planning module 214 may provide information of a tourist attraction as-and-when the users arrive at the location of the said tourist attraction. This is facilitated by monitoring the distance between the current location of the display device 104 and the location of the tourist attraction. The current location of the display device 104 may be obtained from a GPS module present within the display device 104.

In an embodiment, the travel planning module 214 may be configured to update, in a real time, the travel itinerary and hence the travel itinerary/travel plan is adaptive. In some embodiment, the travel itinerary may be updated based upon factors including, but not limited to, weather, traffic, events, holidays and accidents etc. In one example, if the weather is bad, then the travel planning module 214 may guide the user to initially visit the tourist attractions present in an indoor area and reschedule the outdoor activities to other days of the trip. The system 102 is capable of connecting to an internet and/or other resources to monitor the aforementioned factors that may facilitate in real time updating of the travel plan. Thus, the system 102, via the behavior prediction module 212 and the travel plan module 214, may provide the personalized travelling plan and the route guidance to the user. The personalized travel plan/itinerary and the guidance information on the travel route pertaining to the trip may be displayed intuitively on the display device 104 of the user.

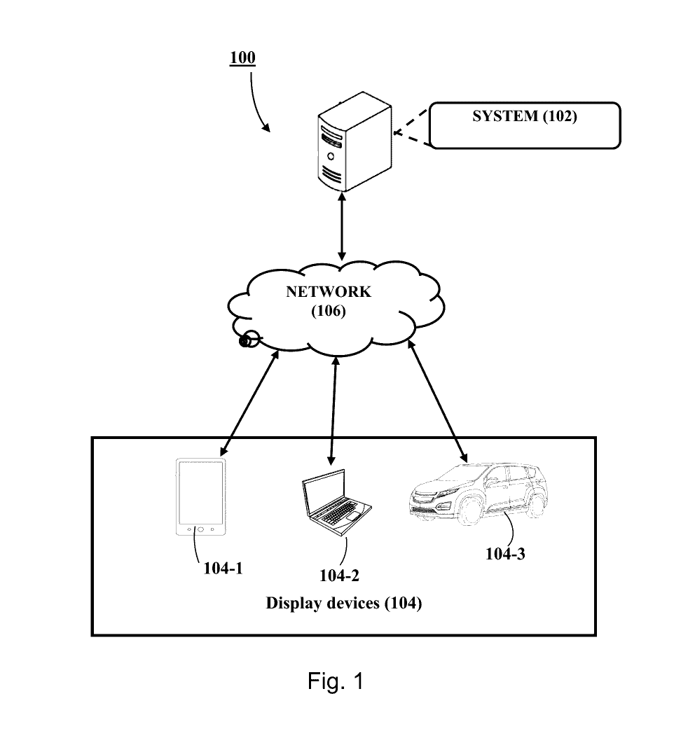

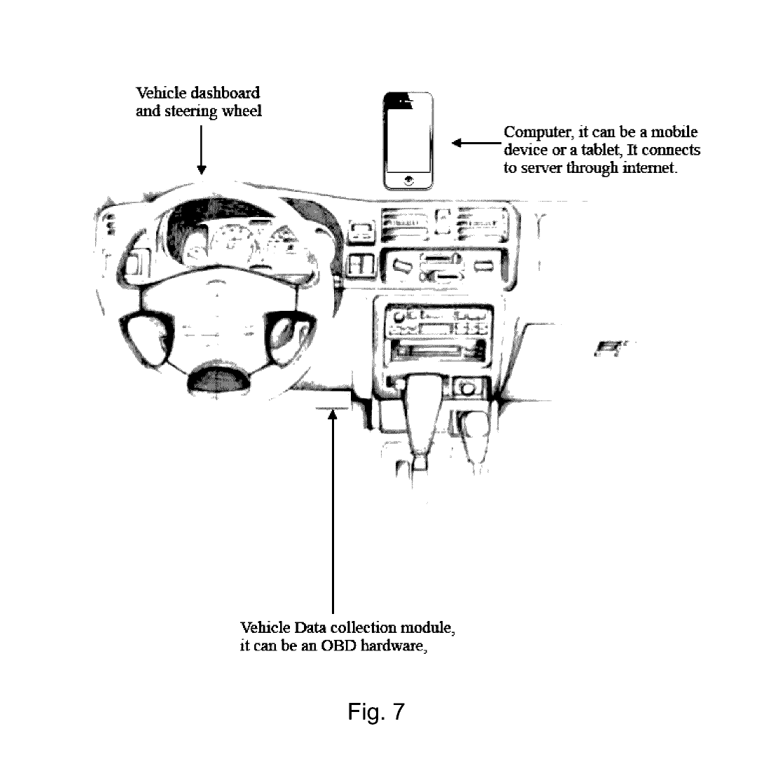

In an embodiment, the system 102 when implemented in conjunction with a vehicle is configured to act as a predictive crash avoidance system and a curve speed warning system as explained in detail hereinafter. In various embodiments, the system 102 may be implemented either as the system 102 communicatively coupled with the display device 104 present in the vehicle as shown in FIG. 1 or an application residing the display device 104 itself. FIG. 7 illustrates the implementation of the system 102 in the vehicle, in accordance with an embodiment of the present disclosure. As shown, the display device 104 present in the vehicle may include a tablet/a mobile device of the user (acting as a driver or a passenger) or an in-vehicle vehicle infotainment system of the vehicle. Further, in this implementation, an on-board diagnostic (OBD) hardware module may be provided that act as vehicle data collection module required for enabling the system 102 to act either as the predictive crash avoidance system or the curve speed warning system.

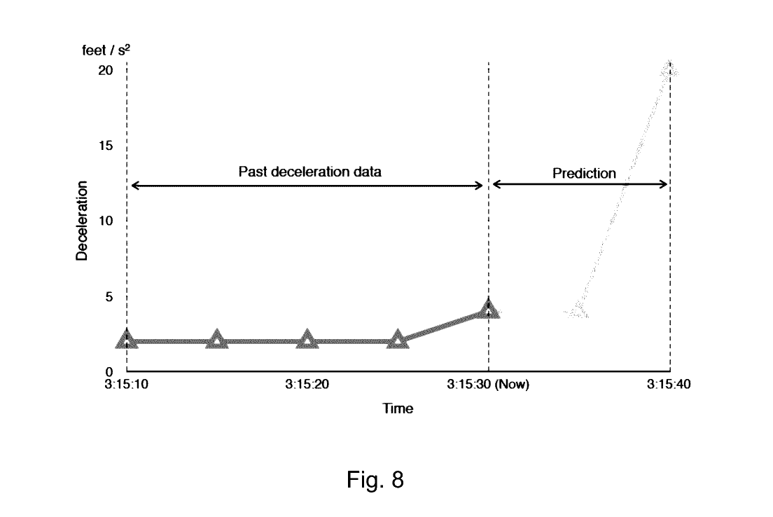

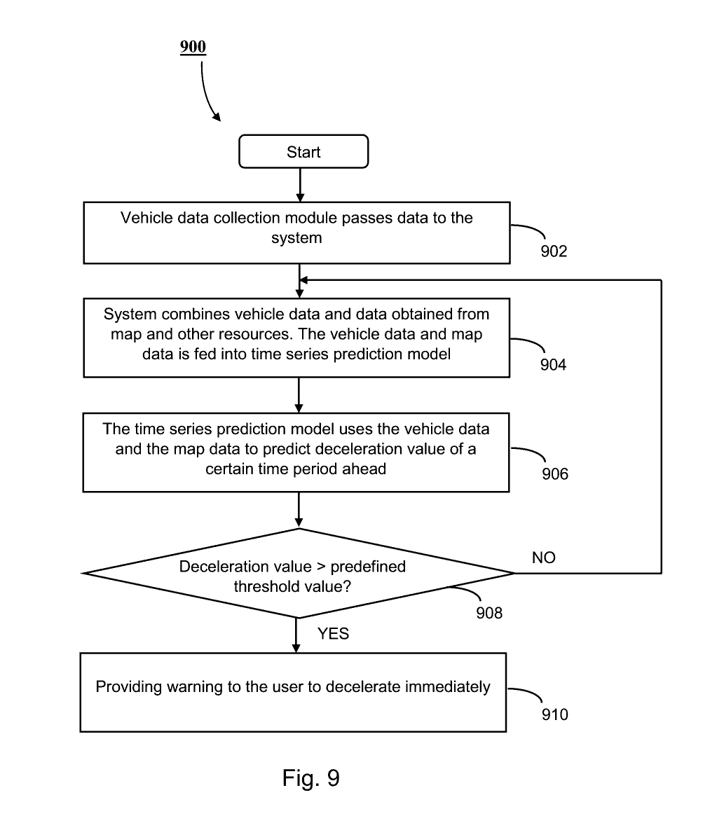

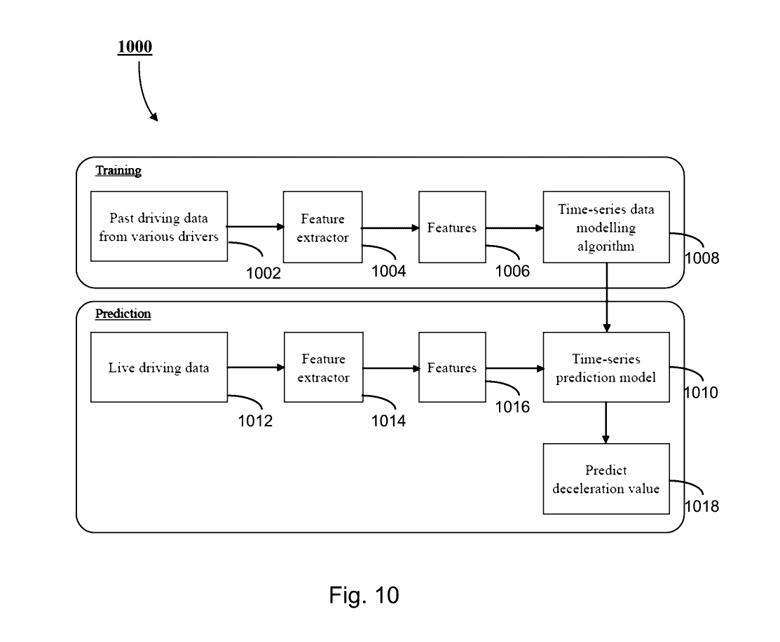

In order to function as the predictive crash avoidance system, the system may employ the crash avoidance module 216 and the warning notification module 222 shown in FIG. 2. The crash avoidance module 216 may comprise a data modeling engine. The data modeling engine may be designed and implemented to analyze time-series data. In general, the methodologies used to analyze the time-series data includes neural network analysis and fuzzy time series analysis. The analysis of the time-series data enables time-series segmentation. The time-series segmentation further facilitates to derive insights about underlying properties of the said time-series data. Typically, the data modeling engines are configured to utilize past data/historical data in order to train a data prediction model and thereafter the data prediction model is adapted to determine future predictions based upon the training of the said data prediction model. The crash avoidance module 216 of the system 102 may be configured to predict the deceleration of the vehicle using the data modeling engine present within the crash avoidance module 216. The said data modeling engine trains a predictive model (also referred hereinafter as a time-series prediction model) that predicts the future deceleration value for the vehicle. Further, the warning notification module 222 may be configured to notify the user with a warning on the display device 104 if the deceleration value exceeds a predefined threshold value. FIG. 8 illustrates a chart demonstrating the time-series based prediction of deceleration of the vehicle. The detailed methodology of predicting the deceleration value and provision of the warning to the user is further explained referring to flow diagram 900 and flow diagram 1000 depicted in FIG. 9 and FIG. 10, respectively, as below.

As shown, at block 902, the vehicle data collection module (shown in FIG. 7) may be configured to transmit vehicle data to the system 102. In an embodiment, the crash avoidance module 216 of the system 102 may receive the vehicle data (including the driving data) from the vehicle data collection module.

At block 904, the crash avoidance module 216 of the system 102 may combine the vehicle data, map data obtained from map, and other data (e.g. weather data, location data and time data) obtained from the other resources such as internet. The vehicle data, the map data, the weather data, the location data and the time data is fed into a time series prediction model.

At block 906, the time-series prediction model may use the vehicle data, the map data, the weather data, the location data and the time data in order to predict deceleration value of a certain time period ahead (e.g., deceleration 10 seconds ahead). The working of the time-series prediction model is further explained in detail referring to FIG. 10 as below.

As shown in FIG. 10, at block 1002, historical vehicle data (including historical driving data) may be received from various users (drivers) or from the vehicle data collection module of the vehicles belonging to such drivers. Further, additional historical data including historical map data, historical weather data, historical location data and the historical time data may be captured.

At block 1004, a feature extractor within the crash avoidance module 216 may be configured to process the past data/historical data in order to generate features 1006 as shown. In one example, the features 1006 extracted may include, but not limited to, a vehicle speed, a vehicle acceleration, a vehicle deceleration, make of a vehicle, a vehicle model year, a vehicle weight, and the like.

At block 1008, the features extracted may processed via a time-series data modelling algorithm to train the time-series prediction 1010 based upon the processing of the one or more features extracted. Now the time-series prediction model 1010 is trained to predict future deceleration values based upon receipt of real time data.

As shown in FIG. 10, at block 1012, a real time data including the vehicle data, map data obtained from map and other data (e.g. weather data, location data and time data) combined at block 904 shown in FIG. 9 is captured. Further, at block 1014, the feature extractor within the crash avoidance module 216 may be configured to process the real time data in order to generate real time features 1016 as shown. The real time features may include, but not limited to, a vehicle speed, a vehicle acceleration, a vehicle deceleration, make of a vehicle, a vehicle model year, a vehicle weight, and the like. The real time features 1016 are fed to the time-series prediction model 1010 trained for prediction via the time-series data modelling algorithm as discussed above. At block 1018, the time-series prediction model 1010 predicts the deceleration value of vehicle using the real time features.

Now referring to FIG. 9, after the prediction of the deceleration value of the vehicle at block 906 using the steps discussed above, then at block 908, the warning notification module 222 may check whether the deceleration value predicted is greater than the predefined threshold value. If the deceleration value predicted is determined to be greater than the predefined threshold value, then at block 910, the warning notification module 222 may provide a warning to the user (e.g. the driver) to decelerate the vehicle immediately. In one embodiment, the warning indicates the driver to brake immediately instead of taking a hard brake at certain time period ahead. The system 102 therefore avoids the driver making hard brakes, hence reducing the probability of crashing of the vehicle.

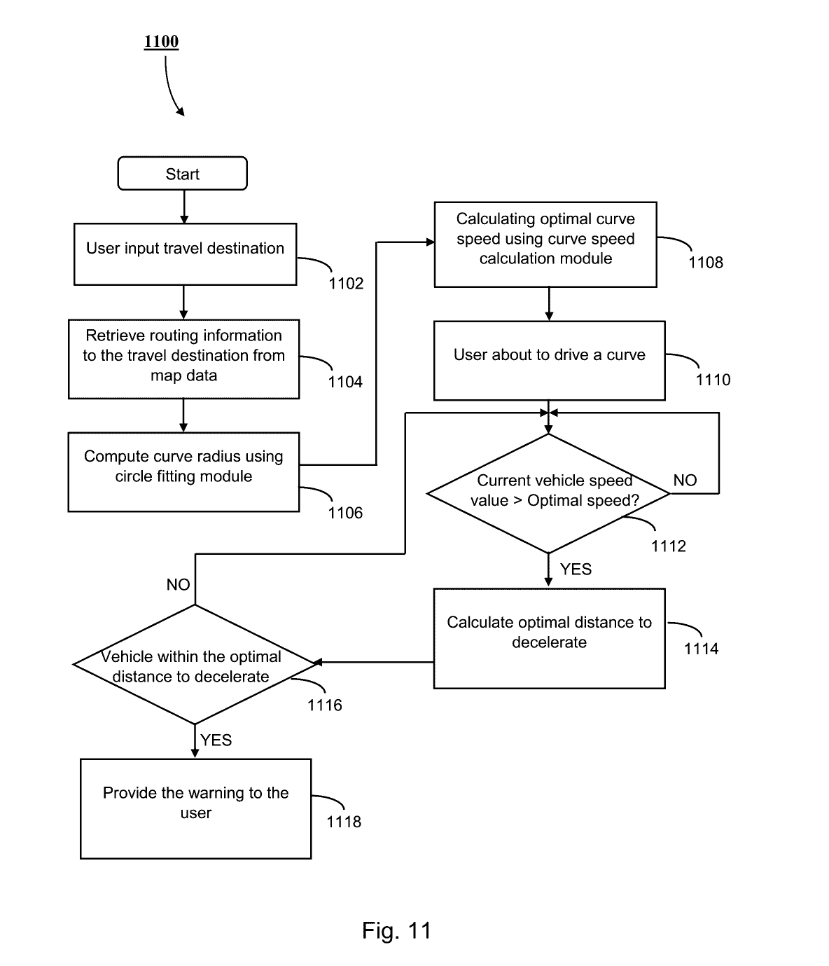

In order to function as the curve speed warning system, the system 102 may employ the circle fitting module 218, the curve speed calculation module 220 and the warning notification module 222 shown in FIG. 2. FIG. 11 illustrates a flow diagram 1100 depicting steps executed by the circle fitting module 218, the curve speed calculation module 220 and the warning notification module 222, collectively, in order to provide a curve speed warning to the user (driver) while entering in the curve on the travel route of the user.

Referring to FIG. 11, at block 1102, the user (hereinafter referred as the driver) enters the travel destination. At block 1104, the system 102 may capture travel route information from the map data. The travel route information indicates routing information from the current position of the vehicle to the travel destination. The travel route information may include at least the shape points of the curves within the route. Further, the system 102 may capture weather information, friction and super elevation rate of positions of the travel route. The system 102 may transmit the shape points of the curves within the route to the circle fitting module 218.

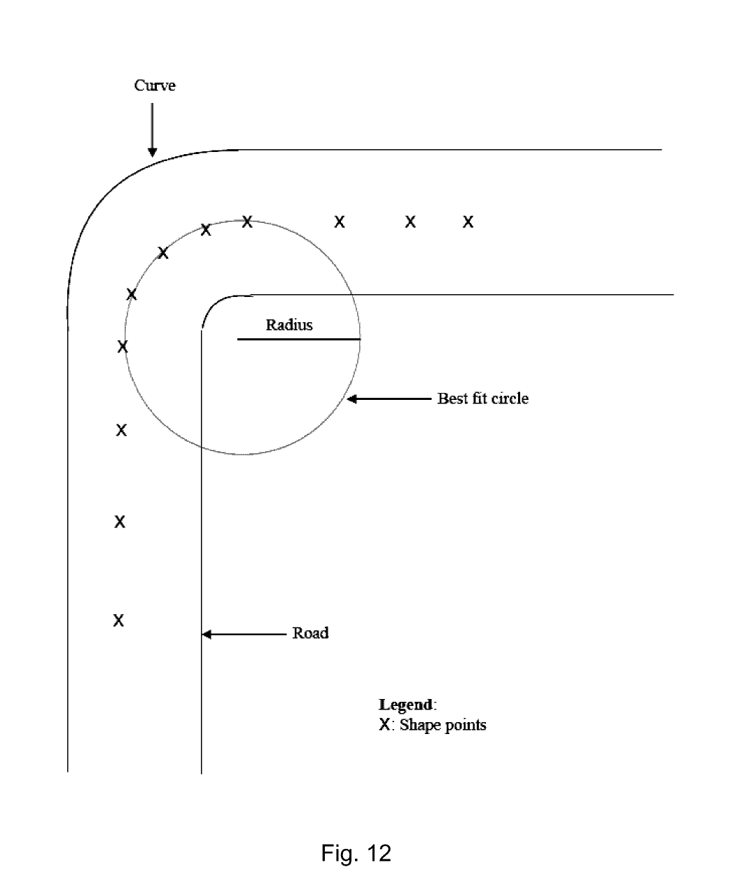

At block 1106, the circle fitting module 218 may compute a curve radius for each curve based upon processing of the shape points of the curves. The best fit circle may be determined by using circle fitting algorithm such as least square fitting algorithm. It is to be noted that determining the best fit circle using the circle fitting algorithm such as least square fitting algorithm is known in the art. FIG. 12 illustrates the circle fitting algorithm for determining the best fit circle of a curve. It must be understood that the shape points of the curves indicate information retrieved by the system 102 from a map, for example, an online map. The shape points may be fed into the curve fitting module 218. The curve fitting module 218 implements the circle fitting algorithm (e.g. least square fitting algorithm) to identify the best circle that matches the shape points inputted into the system 102. The curve radius pertaining to each curve is transmitted to the curve speed calculation module 220.

At block 1108, the curve speed calculation module 220 may calculate the optimal curve speed based upon the curve radius and the additional information including the weather information, the friction and the super elevation rate of positions of the travel route. The optimal curve speed calculated is transmitted to the warning notification module 222. In one embodiment, the curve speed calculation module 220 may calculate the optimal curve speed using the formula (1) as below:

v=\sqrt{15r(0.01E+f)} (1)

Wherein,

‘v’ is an optimal speed to enter the curve

‘r’ is the radius of the circle

‘E’ is the super elevation rate and

‘f’ is the transverse friction force on the road, where ‘f’ is computed using the weather information.

It should be noted that the aforementioned formula (1) may be varied based on incorporation of additional factors.

At block 1110, the warning notification module 222 may detect that the user is about to drive a curve on the travel route. The warning notification module 222 may continuously monitor a current speed of the vehicle throughout the journey. At block 1112, the warning notification module 222 may check whether a current speed of the vehicle at the instance of driving the curve exceeds the optimal curve speed calculated by the curve speed calculation module 220. If it is determined at block 1112 that the current speed exceeds the optimal curve speed, then at block 1114, the warning notification module 222 may calculate a safe optimum distance to decelerate the vehicle while entering a next curve. The safe optimum distance is calculated by the warning notification module 222 using a formula (2) as below:

d=(vc−vo)/2a (2)

Wherein,

‘d’ is a safe optimal distance to decelerate

‘vc’ is the current speed of the vehicle

‘vo’ is the optimal curve speed and

‘a’ is an optimal deceleration rate of the vehicle. The optimal deceleration rate herein indicates the deceleration that is comfortable for most of drivers and the passengers.

It should be noted that the aforementioned formula (2) may be varied based on incorporation of additional factors.

At block 1116, the warning notification module 222 may verify whether the vehicle is within the safe optimum distance to decelerate (d) in order to enter the next curve. At block 1118, the warning notification module 222 may provide a curve speed warning to the driver on the display device 104 if the vehicle is within the safe optimum distance to decelerate. In this manner, the system 102 facilitates in issuing an over speed warning while the vehicle is about to enter the curve on the travel route thereby avoiding any accidents on the travel route.

It must be understood that the current speed of the vehicle may be determined using an inbuilt GPS module of the system 102. Therefore, the system 102 functioning as the curve speed warning system (as described above) may be retrofitted into the vehicles on the roads/routes long as the driver has the display device 104 that can determine its position in a global coordinate system. In some embodiment, the current speed of the vehicle may be captured from vehicle data collection module shown in FIG. 7.

Exemplary embodiments discussed above may provide certain advantages. Though not required to practice aspects of the disclosure, these advantages may include those provided by the following features.

Some embodiments of the present disclosure enable a system and method for determining a personalized travel plan for the user based upon travel preferences of the user, wherein the travel preferences are predicted using supervised learning techniques.

Some embodiments of the present disclosure enable a system and method for providing guidance information to the user pertaining to various tourist attractions, sightseeing activities and indoor/outdoor activities planned for the user as per the personalized travel plan.

Some embodiments of the present disclosure enable a system and method for avoiding crashing of the vehicle by predicting a future deceleration value for the vehicle and notifying the user if the deceleration value exceeds a predefined threshold.

Some embodiments of the present disclosure enable a system and method for providing an over speed warning to the user while entering the vehicle into a curve of the route and determining an optimal safe distance to decelerate the vehicle while entering the curve.

Although implementations for methods and systems for providing personalized travel planning and guidance to the user have been described in language specific to structural features and/or methods, it is to be understood that the appended claims are not necessarily limited to the specific features or methods described. Rather, the specific features and methods are disclosed as examples of implementations for providing personalized travel planning and guidance to the user.

What is claimed is:

1. A method for providing personalized travel planning and guidance to a user, the method comprising:
capturing, by a processor, user's input, user's personal data and user's social networking data, wherein the user's input comprises at least a travel destination and a travel duration;
analyzing, by the processor, the user's input, the user's personal data and the user's social networking data in order to predict user's travel behavior;
identifying, by the processor, a set of tourist attractions from a plurality of tourist attractions, on a travel route, matching with the user's travel behavior;
clustering, by the processor, the set of tourist attractions into a plurality of clusters based upon location information of each tourist attraction;
computing, by the processor, a shortest path and a predetermined duration for one or more tourist attractions associated to each cluster; and
determining, by the processor, a travel itinerary corresponding to at least one sub-duration of the travel duration based upon the shortest path and the predetermined duration computed for the one or more tourist attractions associated to each cluster, wherein the travel itinerary is further displayed on a display device of the user.

2. The method of claim 1, wherein the number of tourist attractions in the set of tourist attractions is based upon the travel duration, and wherein the plurality of clusters is based upon number of days in the travel duration.

3. The method of claim 1, wherein the predetermined duration is computed based upon at least one of a category of the one or more tourist attractions and an average time spend by tourists at the one or more tourist attractions.

4. The method of claim 3 further comprising monitoring a current location of the display device and the location of a tourist attraction and displaying, on the display device, information of the said tourist attraction prior to arriving of the user at the location of the said tourist attraction.

5. The method of claim 4 further comprising predicting a deceleration of a vehicle, associated to the user, at a future time on the travel route and notifying the user with a warning on the display device if the deceleration exceeds a predefined deceleration threshold.

6. The method of claim 5, wherein the deceleration of the vehicle is predicted by:
training, by the processor, a predictive model using at least historical map data, historical vehicle data, historical weather data, historical time data and historical location data;
generating, by the processor, one or more features based upon the training of the predictive model; and
computing, by the processor, based upon real time data and the one or more features, wherein the real time data comprises at least map data, vehicle data, weather data, time data and location data.

7. The method of claim 6 further comprising computing an optimal speed for the vehicle in order to enter a curve on the travel route, wherein the optimal speed is computed by:
capturing, by the processor, travel route information, weather information, friction and super elevation rate of positions of the travel route, wherein the travel route information comprises shape points of the curve;
determining, by the processor, a radius of best fit circle corresponding to a curve based upon the shape points of the curve, wherein the best fit circle is identified using a circle fitting technique; and
calculating, by the processor, the optimal speed to enter the curve based upon the radius, the super elevation rate and a transverse friction force.

8. The method of claim 7 further comprising verifying, by the processor, whether the vehicle is within a safe optimum distance to decelerate, in order to enter a next curve, when a current speed of the vehicle is greater than the optimal speed, and wherein the safe optimum distance is calculated based on the current speed, the optimum speed and an optimal deceleration rate of the vehicle.

9. The method of claim 8 further comprising notifying the user with an over speed warning on the display device if the current position of the vehicle is within the optimal distance.

10. A system for providing personalized travel planning and guidance to a user, the system comprising:
a processor; and
a memory coupled to the processor, wherein the processor is configured to execute programmed instructions stored in the memory in order to
capture user's input, user's personal data and user's social networking data, wherein the user's input comprises at least a travel destination and a travel duration;
analyze the user's input, the user's personal data and the user's social networking data in order to predict user's travel behavior;
identify a set of tourist attractions from a plurality of tourist attractions, on a travel route, matching with the user's travel behavior;
cluster the set of tourist attractions into a plurality of clusters based upon location information of each tourist attraction;
compute a shortest path and a predetermined duration for one or more tourist attractions associated to each cluster; and
determine a travel itinerary corresponding to at least one sub-duration of the travel duration based upon the shortest path and the predetermined duration computed for the one or more tourist attractions associated to each cluster, wherein the travel itinerary is further displayed on a display device of the user.

11. The system of claim 10, wherein the processor further executes a programmed instruction in order to predict a deceleration of the vehicle at a future time on the travel route and notify the user with a warning on the display device if the deceleration exceeds a predefined deceleration threshold, and wherein the deceleration of the vehicle is predicted by:
training a predictive model using at least historical map data, historical vehicle data, historical weather data, historical time data and historical location data;
generating one or more features based upon the training of the predictive model; and
computing the deceleration of the vehicle based upon real time data and the one or more features, wherein the real time data comprises at least map data, vehicle data, weather data, time data and location data.

12. The system of claim 11, wherein the processor further executes a programmed instruction in order to compute an optimal speed for the vehicle to enter a curve on the travel route, wherein the optimal speed is computed by:
capturing travel route information, weather information, friction and super elevation rate of positions of the travel route, wherein the travel route information comprises shape points of the curve;
determining a radius of best fit circle corresponding to a curve based upon the shape points of the curve, wherein the best fit circle is identified using a circle fitting technique; and
calculating the optimal speed to enter the curve based upon the radius, the super elevation rate and a transverse friction force.

13. The system of claim 12, wherein the processor further executes a programmed instruction in order to verify whether the vehicle is within a safe optimum distance to decelerate, in order to enter a next curve, when a current speed of the vehicle is greater than the optimal speed, and wherein the safe optimum distance is calculated based on the current speed, the optimum speed and an optimal deceleration rate of the vehicle.

14. The system of claim 13, wherein the processor further executes a programmed instruction in order to notify the user with an over speed warning on the display device if the current position of the vehicle is within the optimal distance.

15. A non-transitory computer readable medium storing a program for providing personalized travel planning and guidance to a user, the program comprising:
a program code for capturing user's input, user's personal data and user's social networking data, wherein the user's input comprises at least a travel destination and a travel duration;
a program code for analyzing the user's input, the user's personal data and the user's social networking data in order to predict user's travel behavior;
a program code for identifying a set of tourist attractions from a plurality of tourist attractions, on a travel route, matching with the user's travel behavior;
a program code for clustering the set of tourist attractions into a plurality of clusters based upon location information of each tourist attraction;
a program code for computing a shortest path and a predetermined duration for one or more tourist attractions associated to each cluster; and
a program code for determining a travel itinerary corresponding to at least one sub-duration of the travel duration based upon the shortest path and the predetermined duration computed for the one or more tourist attractions associated to each cluster, wherein the travel itinerary is further displayed on a display device of the user.

16. The non-transitory computer readable medium of claim 15, wherein the program further comprises a program code for predicting a deceleration of the vehicle at a future time on the travel route and notify the user with a warning on the display device if the deceleration exceeds a predefined deceleration threshold, and wherein the deceleration of the vehicle is predicted by:
training a predictive model using at least historical map data, historical vehicle data, historical weather data, historical time data and historical location data;
generating one or more features based upon the training of the predictive model; and
computing the deceleration of the vehicle based upon real time data and the one or more features, wherein the real time data comprises at least map data, vehicle data, weather data, time data and location data.

17. The non-transitory computer readable medium of claim 16, wherein the program further comprises a program code for computing an optimal speed for the vehicle to enter a curve on the travel route, wherein the optimal speed is computed by:
capturing travel route information, weather information, friction and super elevation rate of positions of the travel route, wherein the travel route information comprises shape points of the curve;
determining a radius of best fit circle corresponding to a curve based upon the shape points of the curve, wherein the best fit circle is identified using a circle fitting technique; and
calculating the optimal speed to enter the curve based upon the radius, the super elevation rate and a transverse friction force.

18. The non-transitory computer readable medium of claim 17, wherein the program further comprises a program code for verifying whether the vehicle is within a safe optimum distance to decelerate, in order to enter a next curve, when a current speed of the vehicle is greater than the optimal speed, and wherein the safe optimum distance is calculated based on the current speed, the optimum speed and an optimal deceleration rate of the vehicle.

19. The non-transitory computer readable medium of claim 18, wherein the program further comprises a program code for notifying the user with an over speed warning on the display device if the current position of the vehicle is within the optimal distance.
